(19) United States
(12) Patent Application Publication
(10) Pub. No.: US 2010/0231034 A1
(43) Pub. Date: Sep. 16, 2010

(54) TRACKED VEHICLE

(75) Inventor: Helmut Kanzler, Illerberg (DE)

Correspondence Address: FLYNN THIEL BOUTELL & TANIS, P.C., 2026 RAMBLING ROAD, KALAMAZOO, MI, 49008-1631, US

(73) Assignee: KÄSSBOHRER GELÄNDEFAHRZEUG AG, Laupheim (DE)

(21) Appl. No.: 12/311,846

(22) PCT Filed: Oct. 19, 2007
(86) PCT No.: PCT/EP2007/009096

§ 371 Date: May 7, 2010

(30) Foreign Application Priority Data
Oct. 20, 2006 (DE) 10 2006 050 977.3

(51) Int. Cl. B62D 55/08; B62D 55/06; B62D 55/104; B62D 55/14

(52) U.S. Cl. 305/126; 305/127; 305/142

(57) ABSTRACT

The invention relates to a crawler vehicle having a chain drive with two closed chains (110) which are arranged spaced apart in the vehicle transverse direction and which are guided in each case at a first end around a drive wheel (112) and at a second end around a guide wheel (114), and which are designed to be supported against the ground in a ground-side chain section (110a) between the drive wheel (112) and the guide wheel (114). According to the invention, in each case at least one support rail (130) which extends in the vehicle longitudinal direction is arranged between the drive wheels (112) and the guide wheels (114), which support rail (130) is designed to bear permanently against a contact section (110d) of the respective ground-side chain section (110a). The invention also relates to the use in particular for snow-going crawler vehicles, for example piste grooming vehicles.

### FIELD OF APPLICATION AND EXISTING ART

The invention relates to a tracked vehicle, in particular for grooming ski slopes, having a chain drive with two closed chains situated at a distance from each other in a vehicle transverse direction, each of which is passed around a drive wheel at a first end and around a guide wheel at a second end, and which are formed to bear on the ground in a ground-side chain section between the drive wheel and the guide wheel.

Tracked vehicles conforming to the genre are known in general from the existing art. Such a vehicle is described for example in DE 86 17 103 U1. The chain drive has the advantage over a wheel drive that the contact surface of the vehicle is substantially larger. This reduces the surface pressure and counteracts sinking of the vehicle into the undersurface, in particular on loose ground.

A snowmobile is known from DE 69 908 558 T2 that is driven via a single chain. Ice runners are provided on both sides of the chain, which are spaced away from the chain in normal operation. The purpose of these ice runners appears to be to prevent the chain from slipping off when under load on one side. If the chain is under a severe load on one side, it comes into contact with one of the ice runners until the one-sided load ends.

It is viewed as a disadvantage of the tracked vehicles known from the existing art, that despite the chains the surface pressure is not uniformly distributed, but is significantly greater in the vicinity of the wheels than in areas of the chain lying between them. This leads to slippage between the chains and the undersurface when driving on non-solid terrain.

### OBJECT AND SOLUTION

The object of the invention is to refine a generic tracked vehicle so that the slippage between chain and undersurface is reduced, and in particular so that in increase in climbing ability is achieved.

According to the invention, to this end at least one support rail extending in the vehicle longitudinal direction is situated between the drive wheels and the guide wheels in each case, which is designed for constant contact with a particular contact section of the particular ground-side chain section.

During use as intended, the support rails are always in contact with at least part of the contact section of the ground-side chain section. When traveling over a flat or nearly flat undersurface, as is normally the case on ski slopes, the support rails are to a large extent in contact with the ground-side chain section over their entire length. The weight of the vehicle can thereby be led into the ground over an especially large area, so that the vehicle has especially secure traction on a soft undersurface. In addition, uniform alignment of the chain links is achieved in the contact section of the ground-side chain section. This is of particular advantage if there are stud pins on the chain links, which are intended to penetrate into the undersurface. The stud pins, which usually extend outward radially from the chain links, are in an ideal orientation in reference to the chain links of the contact section, in which the stud pins protrude vertically into the undersurface and thus give the vehicle good traction.

Tracked vehicles according to the invention with support rails have a stability and traction on slopes that is significantly better than in the case of tracked vehicles with running wheels. In driving operation, the usual slippage on a snow undersurface that is known from the existing art is reduced to a minimum. Depending on the specific undersurface conditions and the shape of the support rails, the slippage may be eliminated completely. The climbing ability is improved significantly, while the damage to the snow surface is kept slight by the reduced slippage. Furthermore, the reduced slippage results in a significantly increased traveling speed or working speed of the tracked vehicle, and in reduced wear from friction between chain and undersurface.

The support rails are preferably designed to lead at least 50% of the weight of the vehicle into the ground-side chain sections. Preferably, the proportion of the weight that is led through the support rails into the ground-side chain sections and thus into the ground is 80% or more. The indicated values refer in each case to the aggregate of all support rails and the assumed case of a flat and unyielding undersurface. The higher the proportion of weight that is led through the support rails into the ground, the more advantageous are the driving properties of the tracked vehicle and the less the detrimental influence on a snow surface groomed by the tracked vehicle. Especially preferred is a design in which only a negligible proportion of less than 5% of the weight is led into the ground through the guide and/or drive wheels. This negligible portion is preferably led into the ground exclusively through the guide wheels, for example on uneven terrain.

In a refinement of the invention, in addition to the drive and guide wheels situated at the ends, at least one running wheel is provided in each case, situated between the drive wheel and the guide wheel.

Such a tracked vehicle accordingly has both the running wheels between the drive and guide wheels, known from the existing art, and also support rails according to the invention. The combination of the two technologies can be expedient on very irregular undersurfaces, for example on small rocks, where the contact section in which the chain and the support rail are in contact with each other is very short.

In a refinement of the invention, in the contact section of the ground-side chain section in each case there is no running wheel in contact with the respective chain.

In this refinement, the running wheels are accordingly completely replaced by the support rails in the area of the contact section in which the particular support rail is provided. This represents a preferred design, since with the usual undersurfaces encountered on ski slopes additional running wheels in the area of the support rails are not necessary.

In a refinement of the invention, between a chassis of the tracked vehicle on the one hand and the particular support rail on the other hand at least one spring unit is provided, which presses the support rail against the ground-side chain section.

In such a refinement, the chassis is spring-supported on the undersurface through the support rails by means of the spring units. Chassis in this connection means a section of the tracked vehicle on which the drive wheel and/or the guide wheel are rotatably mounted. Accordingly, the spring unit is situated so that it enables a sprung relative motion of the respective support rail relative to the drive wheel and/or the guide wheel. The support rail itself is not rigidly fixed to the chassis, but is movable to a limited measure with respect to the guide wheel and the drive wheel. That makes it possible for a large part of the ground-side chain section to remain in contact with the particular support rail, even on an undulating undersurface. Furthermore, driving comfort is improved, since the springing prevents undamped transmission of irregularities in the terrain to the body of the tracked vehicle. In preferred embodiments a plurality of spring units are provided, which in addition to parallel deflection of the support rail also permit a swiveling motion around a transverse axis of the vehicle.

In a refinement of the invention the spring unit is designed so that it permits a translative mobility of the support rail relative to the chassis exclusively in a plane spanning the vertical and longitudinal directions of the vehicle. Movement of the support rail in the vehicle transverse direction is prevented by a rigid connection of the support rail to the chassis in this respect. This design makes it possible to absorb by means of the support rails the great transverse forces that occur in the case of steering motions of the vehicle. With such steering motions the chains are moved to varying degrees. However, this is only possible when there is secure guidance of the chains in the vehicle transverse direction, preferably achieved by the described rigid connection of the support rail in the vehicle transverse direction. Preferably, the support rail is also not rotatingly pivotable around any axis of rotation, or only around the transverse axis of the vehicle. The rotary movability around the transverse axis of the vehicle permits the support rails to pivot to adjust to ripples in the ground and the like. The prevention of a pivoting motion around the longitudinal and vertical axes of the vehicle achieves advantageous behavior of the vehicle in steering movements due to different chain speeds.

It is especially preferred if the spring unit has a spring stiffness of at least 250 kN/m, preferably at least 500 kN/m. This high spring stiffness prevents the support rails from being deflected severely on undulating or otherwise uneven undersurfaces. This ensures that the support rails can also lead the weight of the vehicle into the ground in such a case, without an unwanted high proportion of the weight of the vehicle, or the entire weight of the vehicle, being led into the ground through the drive wheels and/or guide wheels. The named spring stiffnesses relate to a parallel-displacing deflection of the support rails in the vehicle vertical direction.

In the case of a spring unit that has two separately provided spring elements which are supported at a distance from each other on a common support rail and at a distance from each other on the chassis, the preferred spring stiffness for each spring is at least 125 kN/m. This value refers to a deflection of the support rail in the area in which the corresponding spring is connected to the support rail. In a design in which the spring unit is linked to the chassis through a pendulum element, the spring stiffness relative to a parallel-displacing deflection of the support rail is preferably at least 500 kN/m.

In a refinement of the invention, the spring unit includes at least one leaf spring, which is connected to the support rail or the suspension at two bearing points separated from each other in the vehicle longitudinal direction.

Such a leaf spring, or a bundle of such leaf springs, represents an economical and low-maintenance type of springing. Preferably, the leaf spring or bundle of leaf springs is rigidly or rotatably attached by a middle section to a chassis of the tracked vehicle, and is connected at both ends to the support rail directly or by means of articulated mounts.

In other refinements, the spring unit includes at least one coil spring, which is preferably in the form of a compression spring or a spiral spring that is provided between the chassis and a rotatably mounted spring arm on the chassis side, the spring arm being connected to the support rail so that it can swivel. These types of springing have also proven to be expedient for the purpose described here. Other expedient types of spring units include torsion bar springs, air springs and rubber springs.

In a preferred refinement of the invention, support elements are provided on the springs, against which the support rails bear, where the support elements each have a contact surface on their top which is matched to the shape of the underside of the support rails, so that the surface pressure on the contact surfaces of the support elements, which are simultaneously in contact with the support rail, is less than 2 N/mm² on average, preferably less than 1.5 N/mm².

Preferably, a separate support element is provided for each link of the chain. The support elements form the direct touching partners for the support rails. The weight of the vehicle is led into the ground via contact areas on the underside of the support rails and the support surfaces on the top of the support elements of the straight ground-side chain section. In the simplest case the support surfaces and the undersides of the support rails are of horizontally flat design. Preferably, at least a 50% portion of the total area of the support surfaces is of such horizontally flat design. The support surfaces may have a different shape however, for example a slightly crowned shape, corresponding to the undersides of the support rails. The surface pressure can be kept low by a sufficiently large support surface in relation to the vehicle weight, which results in low-wear operation. It is especially preferred when the surface pressure is under 1.5 N/mm². Preferably the size of the support surface of each support element is at least 1000 mm², preferably at least 1500 mm².

The support elements are preferably made of metal, and form the part subject to less wear in the frictional pairing with the support rails.

In a refinement of the invention, between a chassis of the tracked vehicle on the one hand and the at least one support rail on the other hand a pendulum element is provided, which permits a swiveling motion of the support rail around a transverse axis of the vehicle.

The swiveling motion of the support rail around a transverse axis of the vehicle ensures constant ground contact in the contact section of the chain in almost all driving situations, including in particular on undulating terrain. A pendulum element in this connection means a suspension, in particular an articulated mount, which permits a swiveling motion of the support rail around a horizontal axis, so that the support rail is moved partially vertically. The pendulum element can be designed so that when there is a deflection a force acting against the deflection operates on the support rail, which presses the support rail back into its initial position.

In a refinement of the invention, means of guidance are provided on links of the chain and/or on the support rails, which make it possible to lead forces acting on the chain in a vehicle transverse direction into the support rails.

Such transverse forces arise in particular when the vehicle is used in a hillside location and the terrain is inclined along the vehicle transverse direction. In addition, transverse forces also occur for example due to steering motions. So that the transverse forces do not have to be absorbed exclusively by the guide wheel and the drive wheel, it is advantageous if the chain is formed so that it can lead transverse forces into the support rails. To this end the support rails and the chain links are matched to each other; it can be especially advantageous if they engage each other positively in the vehicle transverse direction.

Especially advantageous in this case are refinements in which the means of guidance include guide profiling on the chain links, where this guide profiling has two guide sections spaced apart in the vehicle transverse direction and extending in the vehicle vertical direction, with the support rail engaging the intermediate space between them.

Depending on the direction of operation of the transverse forces, one of the guide sections is always in contact with the support rail. In this case the support rail is linked to the chassis in such a way that it is able to transmit the forces in the vehicle transverse direction to the chassis of the tracked vehicle.

In another refinement of the invention, the means of guidance include guide profiling on the chain links, where this guide profiling has a guide section extending in the vehicle vertical direction which engages a groove on an underside of the support rail which extends in the vehicle longitudinal direction.

To this end the support rail is divided in two in the longitudinal direction, with a groove extending between the two parts. A groove in connection with this refinement means a continuous recess; it is not important whether the two parts of the support rail are formed in a single piece or are joined together in some other way.

In a refinement of the invention, the support rails are each attached to a support frame, the support frame being designed in each case to be attached to at least one axle of the tracked vehicle extending in the vehicle transverse direction.

Axles in the meaning of this refinement are understood as suspension points provided on the chassis, which are usable for rotatable attachment of running wheels. This refinement makes it possible to make tracked vehicles according to the invention out of conventional tracked vehicles, at only a small cost. Depending on the type of tracked vehicle, there are between two and four or more axles present on each side. These axles can be used to attach the supporting frames. In addition to the permanent retrofitting of tracked vehicles, this also makes a case-by-case conversion possible, so that a choice can be made between running wheels and support rails depending on the undersurface.

In a refinement of the invention, support rails are bent upward in the vehicle vertical direction on at least one end.

This shaping of the support rails is advantageous, since the chain running along the support rails cannot catch the ends of the support rails. Preferably, the support rails are bent upward on both the front and the rear ends.

In a refinement of the invention there are rollers mounted on the underside of the support rails, which are in contact with the chain in the contact section when in operation.

The friction between the support rails on the one hand and the chains on the other hand can be reduced by the rollers. The rollers are preferably rubber rollers mounted on roller bearings, which preferably have a diameter between 1 cm and 5 cm and are spaced between 2 cm and 20 cm apart. Larger roller diameters and roller intervals are also conceivable, however, and may be expedient depending on the concrete design. In another refinement the rollers may also be provided on the chain side, in particular on the chain links.

In a refinement of the invention support elements are provided on the chains, on which the support rail bears, the support elements each having on their top side at least one roller that is mounted so that it can rotate around a transverse vehicle direction.

Such a design serves to reduce the friction on the support elements. The support elements, which preferably are each assigned to a chain link and firmly connected to it, result in reduced wear on the support rails due to the rollers. The rollers preferably have a width that is approximately the same as the width of the support rails. They are preferably mounted on the support elements by means of simple sliding bearings. In a special design, a plurality of rollers situated coaxially next to each other or a plurality of rollers situated parallel next to each other may also be provided for each support element. The design with a plurality, preferably two coaxial rollers, serves to prevent the rollers from bending due to the weight of the vehicle. The design with two or more parallel rollers per support element counteracts buckling of the support elements under the influence of the vehicle weight introduced by the support rail.

In a refinement of the invention there are at least two support rails on each chain, each of which is designed in a contact section for constant contact with the ground-side chain section, with the contact sections overlapping in the vehicle longitudinal direction.

The two support rails are accordingly provided on the same chain. At the same time however they are spaced apart from each other in the vehicle transverse direction, so that in an overlap section they may be in contact simultaneously with the same chain link. Such a design makes it possible to burden the ground-side section of the chains almost completely with the weight of the tracked vehicle, so that nearly optimal distribution of the weight on the chains is achieved.

In a refinement of the invention, the support rails are made of a plastic, at least in the area of a lower contact surface that is designed for contact with the ground-side chain section. In addition, the support rails are preferably made of a plastic in the area of lateral contact surfaces which are provided for contact with the guide sections on the chain side that extend in the vehicle vertical direction. In this case separate plastic sections may be provided on the lower contact surface of the support rails on the one hand and on the lateral contact surfaces of the support rail on the other hand. Plastic elements extending a single storey from the lateral contact surfaces to the lower contact surface may also be provided. In the simplest case, the support rail may be manufactured entirely or substantially from plastic. It is preferred, however, if a plastic layer less than 12 mm thick is provided on the lower and/or lateral contact surfaces. This plastic layer covers sections of a basic body of the support rail, which is preferably of metal.

Possible plastics are for example polyurethane and polyethylene, in particular polyethylene PE 1000. The use of polyamide is regarded as particularly advantageous, in particular PA6 or PA12.

A special design provides that the lower and/or lateral contact surfaces be formed of a plurality of discrete contact surface sections. These contact surface sections are preferably produced separately and then either joined together or installed on the support rail in the unjoined state. Thus it is possible for example to assemble the lower contact surface from individual segments, which in an especially preferred design are made of different materials. Thus it is possible to respond specifically to the different load profiles in different areas of the support rail.

In a preferred design of the invention, a support rail oriented in the longitudinal guiding direction is assigned to each chain to guide a section of the particular chain that faces away from the ground. This support rail prevents the chain from sagging when it is transported forward in the direction of vehicle travel on the side facing away from the ground, or is transported to the rear opposite the direction of travel when driving backward. The support rail preferably extends approximately over the length of the support sections assigned to the chain. It preferably occupies an area of at least 60% of the distance between the drive wheel and the guide wheel of the particular chain.

To reduce the friction, the support rail is made of a plastic, at least in the area of an upper contact surface, which is designed for contact with the section facing away from the ground. The plastics preferred for this are identical to the preferred plastics for the support rails.

### BRIEF DESCRIPTION OF THE DRAWINGS

Additional advantages and features of the invention are derived from the claims and the following description of preferred exemplary embodiments of the invention, which are explained on the basis of the drawings. The figures show the following:

FIG. 1: a tracked vehicle according to the existing art, without support rails according to the invention;

FIG. 2: a first embodiment of a tracked vehicle according to the invention, with support rails mounted without springing;

FIGS. 3, 3a and 3b: a second embodiment of a tracked vehicle according to the invention, having support rails sprung with leaf springs, as well as detail views of the support rail with the leaf spring subjected to force and slewed;

FIG. 4: a third embodiment of a tracked vehicle according to the invention, having a support rail sprung with a leaf spring and two running rollers for each chain;

FIGS. 5 and 5a: a fourth embodiment of a tracked vehicle according to the invention, with springing that is formed by pivoting arms sprung with spiral springs or torsion bar springs;

FIGS. 6 and 6a: a fifth exemplary embodiment of a tracked vehicle according to the invention, having supports sprung with coil springs and on which support rails are rotatably mounted, as well as a detail view of the support rail in a rotated state;

FIGS. 7 and 7a: a sixth exemplary embodiment of a tracked vehicle according to the invention, having rotatably mounted supports to which the support rails are attached, sprung with coil springs, as well as a detail view of the support rail in a rotated state;

FIG. 8: a seventh embodiment of a tracked vehicle according to the invention, having three support rails per chain;

FIG. 9: an eighth embodiment of a tracked vehicle according to the invention, having support rails that are provided with rollers;

FIGS. 10a and 10b: the chain and the contact rails of the embodiment in FIG. 7, in a sectional view;

FIGS. 11a and 11b: a variant of a support rail of a tracked vehicle according to the invention;

FIGS. 12a and 12b: another variant of a support rail of a tracked vehicle according to the invention;

FIG. 13: a special embodiment of a support and guide element for use on a chain of a tracked vehicle according to the invention; and

FIGS. 14 through 16: additional embodiments of support and guide elements for use on a chain of a tracked vehicle according to the invention.

### DETAILED DESCRIPTION OF THE EXEMPLARY EMBODIMENTS

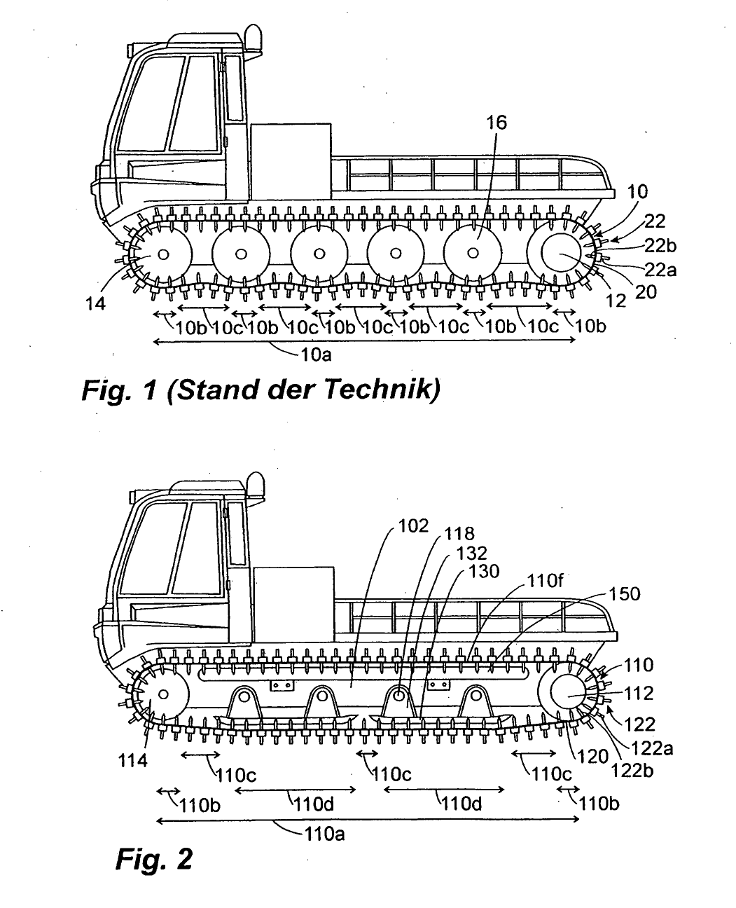

FIG. 1 shows a tracked vehicle according to the existing art. Such a tracked vehicle has two chains 10, which are spaced apart from each other in the vehicle transverse direction. In the side view in FIG. 1, as well as in the subsequent drawings of exemplary embodiments of the invention, only one chain is depicted in each case. However, the construction is identical for both chains of a tracked vehicle.

Chain 10 of the tracked vehicle of FIG. 1 is placed around a drive wheel 12 at the rear end of the vehicle and around a guide wheel 14 at the front end of the vehicle. Running wheels 16 are provided between drive wheel 12 and guide wheel 14. Chain 10 itself consists of a chain belt 20 to which chain links 22 are attached. These chain links 22 each have an outward-projecting stud pin 22a, as well as an inward-projecting guide element 22b. The guide element 22b of the chain links forms the part of the chain that is in direct contact with the running wheels 16 and the guide wheel 14.

The weight of the tracked vehicle is led into the undersurface through chain 10. As that occurs, however, a ground-side section 10a of chain 10 is not uniformly loaded. Instead, the introduction of force into contact sections 10b occurs primarily in the area of the wheels 16, so that these contact sections 10b bear the majority of the weight of the tracked vehicle. In consequence, chain links 22 and in particular guide elements 22b and stud pins 22a are especially loaded in contact sections 10b. In intermediate chain sections 10c, only a small amount of the weight of the tracked vehicle is led through the connection of the chain links in these chain sections 10c to the contact sections 10b of chain 10.

The stud pins 22a, whose objective is to be pressed into the undersurface in order to reduce the slippage between chain and undersurface, are pressed into the undersurface completely or nearly completely only in the chain sections 10b. In the intermediate sections 10c the stud pins 22a of the chain links 22 are pressed only slightly into the undersurface, since the requisite weight of the tracked vehicle operating from above is lacking. The reduction of slippage by the stud pins 22a can therefore be accomplished only by a few stud pins 22a in contact sections 10b. Furthermore, during driving operation vibrations occur in the area of the intermediate chain sections 10c, which result in uneven driving behavior and severe damage to the undersurface. The depicted construction according to the existing art also results in heavy wear on the stud pins 22a, since they—if they are located in the contact sections—must bear a large part of the weight of the tracked vehicle.

FIG. 2 shows a first embodiment of a tracked vehicle according to the invention. In accordance with the existing art of FIG. 1, this tracked vehicle uses a chain drive that has two chains 110, which are placed around guide wheels 114 at a front vehicle end and around drive wheels 112 at a rear vehicle end. Instead of the running wheels 16, the tracked vehicle according to the invention depicted in FIG. 2 has support rails 130, which are attached via supports 132 to two suspension points 118 constructed in the form of axles, which in turn are rigidly connected to a chassis 102 of the tracked vehicle. Accordingly, the support rails are rigidly attached to the chassis 102 of the tracked vehicle. As can be seen from FIG. 2, the support rails 130 have significant effects on the behavior of chain 110 at the latter's ground-side section 110a. Chain 110 bears against guide wheel 114 and against drive wheel 112 in contact sections 110b, and against support rails 130 in contact sections 110d. Only in small intermediate sections 110c does chain 110 bear against neither a wheel 112, 114 nor a support rail 130. However, these sections 110c of chain 110 are short enough so that their negative effect is negligible.

Nearly the entire weight of the vehicle, i.e., more than 90% of it, is led through support rails 130 into chain 110 and from there into the undersurface. Guide wheel 114 and drive wheel 112 assume a weight-bearing function briefly only on undulating terrain.

Section 110f of chain 110, which faces away from the ground, is supported by a supporting rail 150, so that it does not sag to a troublesome degree.

Because of contact sections 110d, in which the chain is ideally loaded, a high degree of adhesion with the undersurface is achieved. Stud pins 122a of chain links 122 in contact sections 110d penetrate completely or nearly completely into the undersurface, thereby making it possible to drive almost entirely without slipping. Because the sections 110c, in which the chain is not subjected to a force from above transverse to its extension, are very short, there are no disturbing upswings of these chain sections 110c.

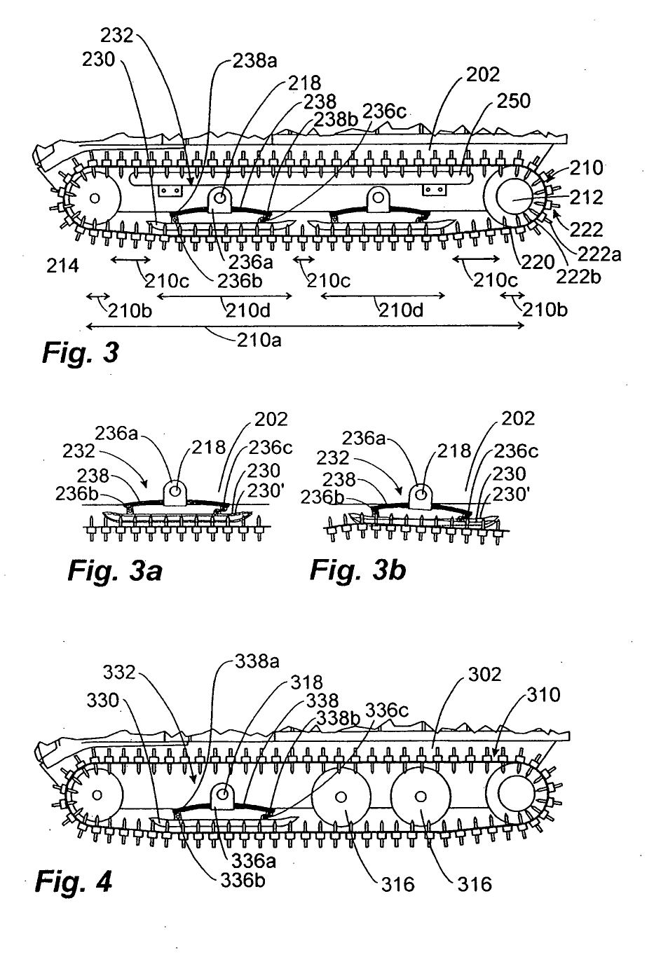

FIGS. 3, 4, 5, 6, 7, 8, 9 show additional embodiments of tracked vehicles according to the invention. The tracked vehicles are only partially depicted, however, since the construction of the tracked vehicles is not significant for the present invention. Components of these additional embodiments which correspond in terms of construction and function to the components of the embodiment in FIG. 2, are identified by reference labels whose last two digits agree with the reference labels of the corresponding components of the embodiment in FIG. 2.

The embodiment in FIG. 3 also has a chain 210, as well as a drive wheel 212 and a guide wheel 214. A ground-side section 210a of chain 210 is guided in two contact sections 210d by support rails 230, these being attached to the chassis 202 of the tracked vehicle by means of a support frame 232a. The support frames 232 each have a leaf spring bundle 238, which is connected to a spring bundle holder 236a, which is mounted so that it can pivot around an axle 218 fixed to the chassis. On the side of support rail 230, the leaf spring bundle is connected at a first end 238a to support rail 230 through a simple joint 236b. On the opposite side 238b leaf spring bundle 238 is connected to support rail 239 through a double joint 236c with compensating pivoting arm; the compensating pivoting arm makes it possible to change the length of leaf spring bundle 238 in the vehicle longitudinal direction.

As can be seen from FIGS. 3a and 3b, the suspension of support rails 230 on a swivel-spring bundle holder 236a with leaf spring bundle 238 permits both parallel shifting of support rail 230 and tilting of support rail 230 relative to its starting position 230′.

FIG. 4 shows a third embodiment of a tracked vehicle according to the invention. This design uses support rails 330 that are movably linked to the chassis 302 of the tracked vehicle by means of a support frame with a leaf spring bundle 338, in the same manner as the support rails 230 of the embodiment in FIG. 3. In a departure from the embodiment in FIG. 3, however, only one support rail is provided per chain. Otherwise, each chain uses two running wheels known from the existing art. Such a combined embodiment is especially advantageous on an irregular undersurface, or for example on small rocks, since the advantages of support rails are less pronounced on such an undersurface.

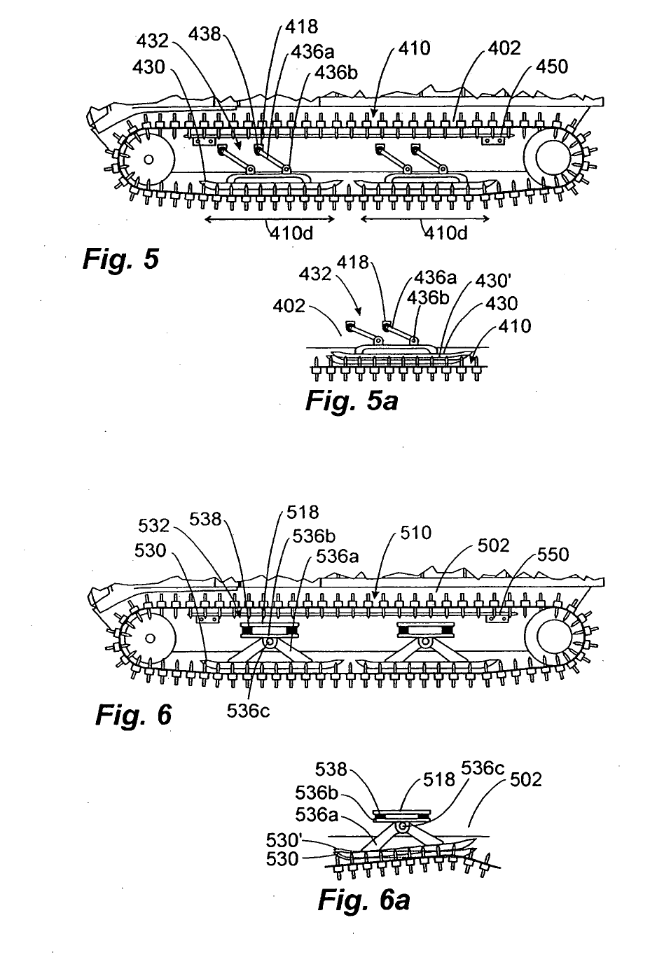

In the embodiment of a tracked vehicle according to the invention according to FIG. 5, as in the embodiment in FIG. 3, two support rails 430 are provided, each of which is connected by means of a support frame 432 to the chassis 402 of the tracked vehicle. The support frames each have two pivoting arms 436a, which are swivel-mounted on the chassis. The support rails 430, which are connected through joints 436b to the pivoting arms 436a, are pressed against a ground-side contact section 410d of chain 410 through torsion bar springs 438 or spiral springs 438, which are connected on one side to the pivoting arms 436a and on the other side to supports 418 that are rigidly attached to the chassis.

As FIG. 5a shows, support rails can be deflected parallel out of their starting position 430′ against the force of the spiral springs 438 or torsion bar springs 438 by means of the link rods 436a, and thus adapt to an undulating undersurface.

In an alternative embodiment, not shown, only one pivoting arm is provided per support rail. In such an embodiment, a swiveling motion of the support rails around a vehicle transverse axis is also possible.

FIG. 6 shows a fifth embodiment of a tracked vehicle according to the invention. In this design there are again two support rails 530 provided per chain 510, each of which is connected through a support frame 532 to the chassis 502 of the tracked vehicle. The support frame includes attaching sections 536a that are rigidly connected to the support rails 530, which attaching sections extend upward in the vehicle vertical direction from the support rails 530. The attaching sections are swivel-connected to lower spring plates 536b through joints 536c. The lower spring plates 536b are operationally connected, through two spring elements 538 formed with coil springs, to upper spring plates 518, which are attached to the chassis 502 of the tracked vehicle, for example by welding. Like the embodiment in FIG. 3, this design of the support rails 530 and the mounting of the support rails opposite a starting position 530′ permit both a swiveling motion around a vehicle transverse axis and a parallel deflection of the support rails 530 in their entirety. Both are shown pictorially in FIG. 6a.

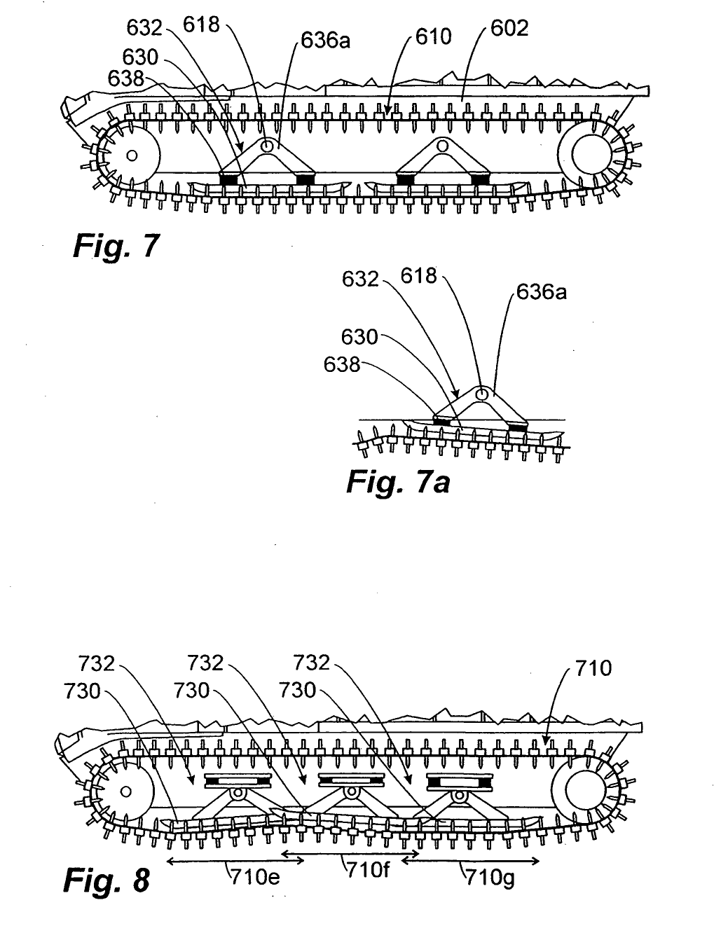

FIG. 7 depicts another embodiment of a tracked vehicle according to the invention, where two support rails 630 are again provided to guide a chain 610. The mounting of these support rails 630 on chassis 602 corresponds approximately to the embodiment in FIG. 6. Again support frames 632 are used, which have spring elements 638 with coil springs and ensure swiveling mobility of the support rails 630 relative to the chassis 602. In a departure from the embodiment in FIG. 6, however, the coil springs 638 are provided between the support rails 630 and a respective assigned support member 636a, so that when the support member 636a swivels relative to the chassis 602 they are also swiveled.

The mobility of this arrangement can be seen from FIG. 7a.

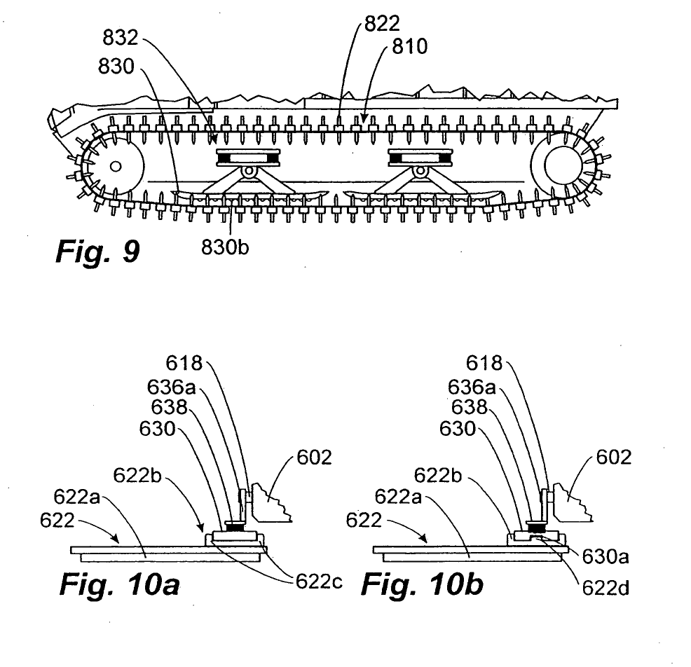

FIGS. 8 and 9 show embodiments of a tracked vehicle according to the invention which represent variations of the tracked vehicle in FIG. 6.

In the tracked vehicle in FIG. 8, the support rails 730 and the support frames 732 are identical to the corresponding components of the embodiment in FIG. 6. But in contrast to the latter, three support rails 730 are provided for each chain, whose contact areas 710e, 710f, 710g overlap partially in the vehicle longitudinal direction. This makes a continuous contact area on the chain 710 possible. As may be seen from FIG. 8, because of the design of support frame 732 almost complete contact of the support rails 730 with the chain 710 is possible, even on undulating ground.

The embodiment of a tracked vehicle according to the invention in FIG. 9 corresponds to the embodiment in FIG. 6, except for one difference. In contrast to the latter, the support rails 830 do not bear against the chain links 822 with a flat area, but have rollers 830b that are situated on the underside of the support rails 830. These rollers are mounted by means of roller bearings or other low-friction bearings, and reduce the frictional resistance between the support rails 830 and the chain links 822. The rollers 830b depicted in FIG. 9 are not true to scale, but serve only for clarification. It is expedient to use smaller rollers, and significantly more of them per support rail.

An alternative design with rollers provides that the rollers are not provided on the support rails, but on support elements that are rigidly connected to the chain. Corresponding designs will also be described below in reference to FIGS. 14 through 16.

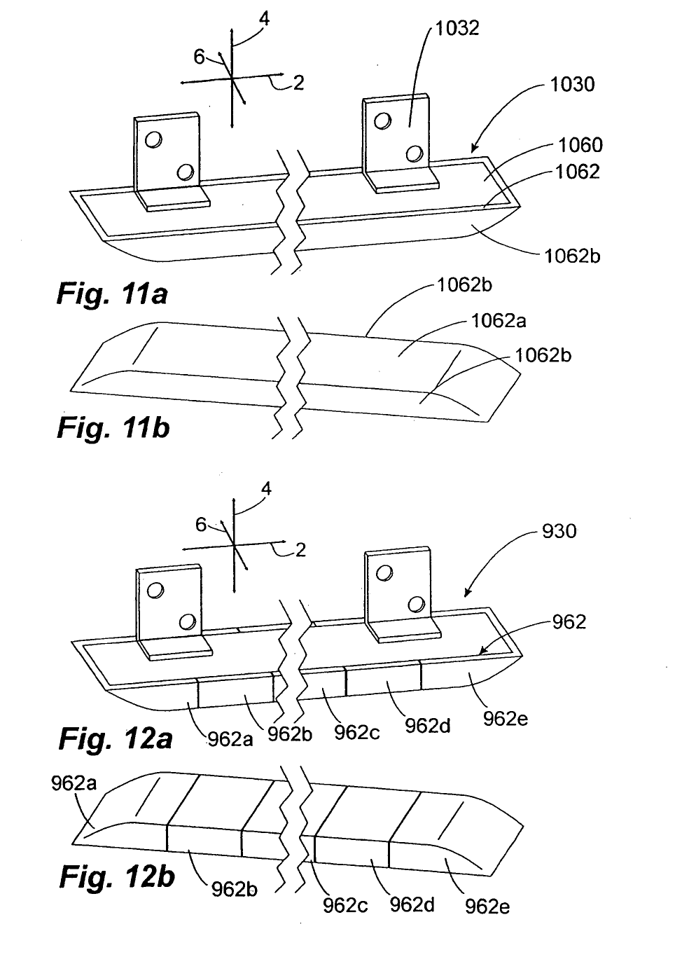

It is true of all of the embodiments shown, that the support rails lead the weight of the vehicle into the undersurface entirely or almost entirely through the chains. It is also true of all of the exemplary embodiments, that the support rails are translatively and/or rotationally movable only in a plane spanning the vehicle vertical direction and the vehicle longitudinal direction. In the vehicle transverse direction, the support rails are each fixed in a rigid position relative to the chassis. This makes it possible for the support rails to absorb the transverse forces which arise at the chain, in particular following steering motions. Details of the support rails and the chain-side support elements will be described in connection with FIGS. 11 through 16.

Alternative embodiments for the design of the support rails and for the design of chain-side support and guide elements are provided below. These designs are realizable with all of the vehicle designs above.

FIGS. 10a and 10b show the mutual engagement of support rails 630 and chains 610 using the example of the embodiment from FIG. 7. It can be seen that support and guide elements 622b which have a shape that is profiled in the vehicle transverse direction are provided on the chain links 622. In the case of the exemplary embodiment in FIG. 10a this shape is approximately U-shaped, and has two guide sections 622c as the legs of the U-shape. Support rail 630 has a width that largely fills out this U-shaped profiling of the support and guide element 622b between the guide sections 622c. When forces act on the chassis 602 or the chain 610 in the vehicle transverse direction, the profiling prevents the guide rails 630 on the one hand and the chains 610 or the support and guide elements 622b of the chains 610 on the other hand from coming out of the mutual engagement. Instead, the forces can be transmitted from the chassis 602 to the chains 610 and vice versa.

In the embodiment in FIG. 10b, in addition to the lateral boundary offered by the U-shaped support and guide element 622b with the guide sections 622c, a center guide section 622d is also provided, which engages a corresponding groove 630a in support rail 630. The hold is further improved by this additional guide section 622d and the groove 630a.

FIGS. 11a, 11b show an embodiment of a support rail for use with a tracked vehicle according to the invention. Support rail 1030 can be firmly connected to the chassis of a tracked vehicle according to the invention through angle supports 1032. Preferably, however, the depicted support rail is fixed by means of support angles 1032 on a support frame, which permits spring-loaded mobility of the support rail in a plane spanning the vehicle vertical direction 2 and the vehicle horizontal direction 4. The support rail 1030 itself is made up of a metal rail core 1060 and a contact layer 1062 applied to it and approximately 10 mm thick. The contact layer 1062 consists of the plastic polyamide PA6, and is intended as a wearing layer. The main load is caused on a lower contact surface 1062a. This lower contact surface 1062a represents a sliding surface, which slides along during operation over the ground-side chain section or over support elements that are connected to the ground-side chain section. The lateral contact surfaces 1062b are likewise under heavy demand in operation. During operation they come into frictional contact with lateral guide sections provided on the chain, in particular ensuring the guidance of the chain in the vehicle lateral direction. Since tracked vehicles according to the invention are steered by driving the two chains at different speeds, causing high transverse forces, at the same time there are high surface pressures in the area of the lateral contact surfaces 1062b. The use of polyamide plastic in the area of these surfaces ensures that operating reliability and wear-resistance will nevertheless be high.

In the embodiment in FIGS. 12a, 12b, the construction of the depicted guide rail 930 corresponds essentially to the construction of the guide rail 1030 depicted in FIGS. 11a and 11b. But in contrast to the embodiment in FIGS. 11a and 11b, the plastic layer 962 in this second embodiment is formed by separate segments 962a, 962b, 962c, 962d, 962e. The use of such segments has several advantages. On the one hand, manufacturing plastic parts of smaller size involves simpler manufacturing technology. This is especially true of polyamide parts. Furthermore, such construction allows individual segments 962a, 962b, 962c, 962d, 962e to be replaced in the event of wear. A third advantage is that this makes it possible to provide the support rail with segments of different design in terms of their shape and in particular their material, in areas of differing demand. For example, the front-most segment 962a can be made of an especially strong plastic, while the subsequent segments 962b, 962c, 962d, 962e can consist of a plastic that was chosen with regard to low static and/or sliding friction with the chain-side support elements.

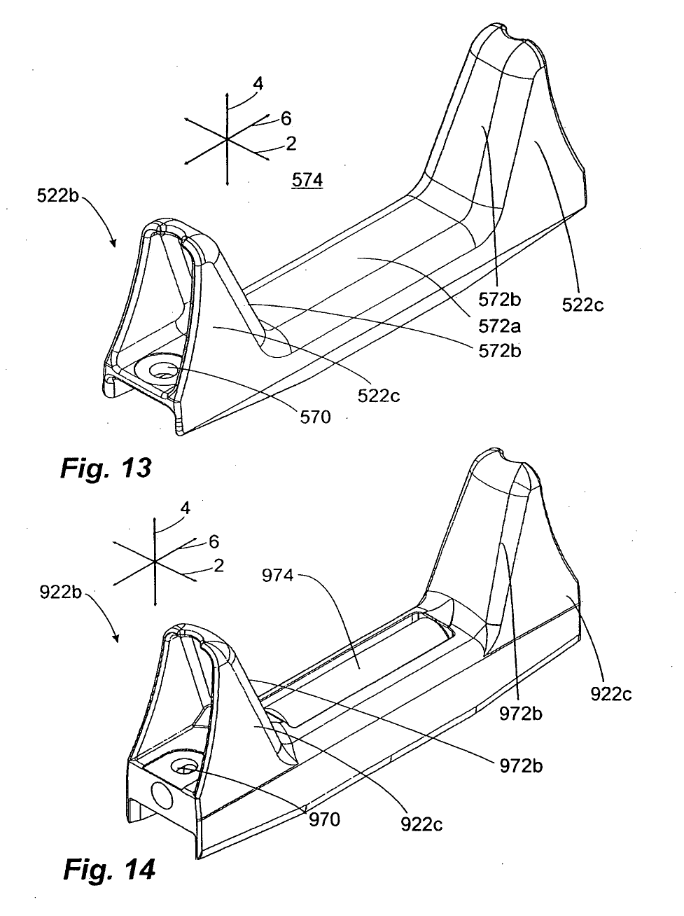

FIG. 13 shows such a support and guide element 522b. This support and guide element can be rigidly attached through holes 570 bored in a chain link. Preferably, each link of the chain is provided with such a support and guide element 522b. The support and guide element 522b has an approximately U-shaped form, on the floor of which a flat support surface 572a is provided. Two guide sections 522c extending upward in the vehicle vertical direction 4 each have a lateral guide surface 572b on their sides directed toward each other. The support rail is situated in the free area 574, which is bounded laterally by the lateral guide surfaces 572b and at the bottom by the support surface 572a, when the corresponding chain link, to which the support and guide element 522b is assigned, belongs to the ground-side floor section of the chain.

The design of the contact surface 572a is of particular relevance. Because of the matching to the likewise flat underside of a support rail, the area in which the support rail and the support surface 572a are directly in contact is comparatively large. Preferably its dimensions are such that the aggregate of all support and guide elements 522b that simultaneously absorb the weight of the vehicle is sufficiently great to limit the surface pressure in the area of the support surfaces 572a to under 2 N/mm² on average. This enables the desired low wear to be achieved. The total size of the depicted flat support surface 572a is approximately 2900 mm².

FIG. 14 shows an alternative design of a support and guide section 922b. The basic construction corresponds to the embodiment in FIG. 13. Similar components and elements are identified with reference labels whose last two digits match.

In contrast to the embodiment in FIG. 13, however, a roller 974 rotatable around a vehicle transverse axis is provided on the top, which is mounted using friction bearings (not shown). In an embodiment of a tracked vehicle according to the invention with chains in which such support and guide elements 922b are provided, because of such rollers 974 there is hardly any sliding friction between the support rails and the support and guide elements 922b. Instead, the support rollers roll over the support and guide elements 922b. Sliding friction exists in this case only in the area of the lateral guide surfaces 972b.

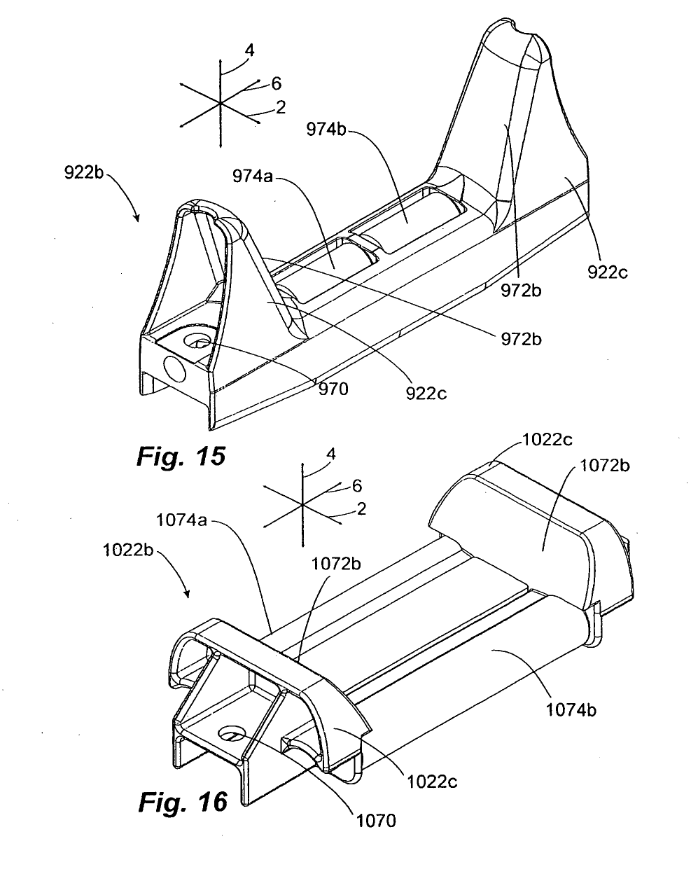

A variant constructed on this basis is depicted in FIG. 15. This differs from the variant in FIG. 14 in that two rollers 974a, 974b are provided which are situated coaxially one behind the other in the vehicle transverse direction 6. This makes it possible to prevent deformation of the rollers as the result of loading with the weight of the vehicle. In contrast to the embodiment in FIG. 13, in which sagging of roller 964 is possible, in the embodiment in FIG. 15 only the axle of the rollers 964a, 964b is slightly bent by the weight of the vehicle, while the rollers 964a, 964b themselves are not bent, or only to a small degree.

The embodiment 1022b in FIG. 16 likewise has two separate rollers 1074a, 1074b; these are situated parallel to each other and are spaced apart from each other in the vehicle longitudinal direction 2. The result of such a design is that the contact and guide element 1022b assumes a set position when it is in contact with the support rail, which is defined by the fact that in this position both rollers 1074a, 1074b are bearing against the underside of the support rail. This prevents tipping of the support and guide element 1022b, and thus tipping of the entire chain link to which the support and guide element 1022b is rigidly attached.

1. A tracked vehicle, in particular for grooming ski slopes, having a chain drive with two closed chains (110; 210; 310; 410; 510; 610; 710; 810), situated at a distance from each other in a vehicle transverse direction, each of which is passed around a drive wheel (112; 212) at a first end and around a guide wheel (114; 214) at a second end, and which are designed to bear on the ground in a ground-side chain section (110a; 210a) between the drive wheel (112; 212) and the guide wheel (114; 214),
characterized in that
between the drive wheels (112; 212) and the guide wheels (114; 214) is situated in each case at least one support rail (130; 230; 330; 430; 530; 630; 730; 830; 930; 1030) extending in the vehicle longitudinal direction, which is designed to bear constantly against a contact section (110d; 210d; 410d; 710e, 710f, 710g) of the respective ground-side chain section (110a; 210a).

2. The tracked vehicle according to claim 1,
characterized in that
the support rails (130; 230; 330; 430; 530; 630; 730; 830; 930; 1030) are designed to lead at least 50% of the weight of the vehicle into the ground-side chain sections (110a; 210a), preferably at least 80%.

3. The tracked vehicle according to claim 1,
characterized in that
in addition to the drive and guide wheels situated at the ends, at least one running wheel (316) is provided in each case, situated between the drive wheel and the guide wheel.

4. The tracked vehicle according to claim 1,
characterized in that
in the contact section (110d; 210d; 410d; 710e, 710f, 710g) of the ground side chain section (110a; 210a), in each case there is no running wheel in contact with the respective chain (110; 210; 310; 410; 510; 610; 710; 810).

5. The tracked vehicle according to claim 1,
characterized in that
between a chassis (202; 302; 402; 502; 602) of the tracked vehicle on the one hand and the respective support rail (230; 330; 430; 530; 630; 730; 830; 930; 1030) on the other hand at least one spring unit (238; 338; 438; 538; 638) is provided, which presses the support rail (230; 330; 430; 530; 630; 730; 830; 930) against the ground-side chain section (210a).

6. The tracked vehicle according to claim 5,
characterized in that
the spring unit (238; 338; 438; 538; 638) is designed in such a way that it allows a translative mobility of the support rail (230; 330; 430; 530; 630; 730; 830; 930; 1030) relative to the chassis (202; 302; 402; 502; 602) exclusively in a plane spanning the vehicle vertical direction (4) and the vehicle longitudinal direction (2).

7. The tracked vehicle according to claim 5,
characterized in that
the spring unit (238; 338; 438; 538; 638) has a spring stiffness of at least 250 kN/m, preferably at least 500 kN/m.

8. The tracked vehicle according to claim 5,
characterized in that
the spring unit (338) includes at least one leaf spring (338), which is connected to the support rail (330) or the suspension at two bearing points (338a, 338b) separated from each other in the vehicle longitudinal direction.

9. The tracked vehicle according to claim 4,
characterized in that
the spring unit (538; 638) includes at least one coil spring (538; 638), preferably two coil springs (538; 638), which preferably extend approximately in the vehicle vertical direction.

10. The tracked vehicle according to claim 4,
characterized in that
the spring unit (438) includes at least one torsion bar spring (438) or spiral spring (438), by means of which a spring arm (436a) rotatably mounted on the support rail (430) is subjected to a spring force.

11. The tracked vehicle according to claim 1,
characterized in that
support elements (622b, 522b) are provided on the springs, against which the support rails (630) bear, where the support elements (622b, 522b) each have a support surface (572a) on their top which is matched to the shape of the underside of the support rails, so that the surface pressure on the support surfaces of the support elements (522b), which are simultaneously in contact with the support rail, is less than 2 N/mm² on average, preferably less than 1.5 N/mm².

12. The tracked vehicle according to claim 11,
characterized in that
the support surfaces (572a) of the support elements (522b) are of flat horizontal design, at least in some sections, with the total area of the horizontally flat sections (572a) being at least 50% of the sum of the support surfaces (572a).

13. The tracked vehicle according to claim 1,
characterized in that
between a chassis (202; 302; 502; 602) of the tracked vehicle on the one hand and the at least one support rail (230; 330; 530; 630; 730; 830; 930; 1030) on the other hand at least one pendulum element (218, 236a; 318, 336a; 536a, 536b; 618, 636a) is provided, which permits a swiveling motion of the support rail (230; 330; 530; 630; 730; 830) around a vehicle transverse axis.

14. The tracked vehicle according to claim 1,
characterized in that
on links (122; 222; 622) of the chains (110; 210; 310; 410; 510; 610; 710; 810) and/or on the support rails (130; 230; 330; 430; 530; 630; 730; 830) means of guidance (622c, 622d, 630a; 522c; 922c, 1022c) are provided, which make it possible to lead forces acting on the chain (110; 210; 310; 410; 510; 610; 710; 810) in the vehicle transverse direction (6) into the support rails (130; 230; 330; 430; 530; 630; 730; 830).

15. The tracked vehicle according to claim 14,
characterized in that
the means of guidance include a guide profile (122b; 222b; 622b) on the chain links (122; 222; 622), where this guide profile (122b; 222b; 622b) has two guide sections (622c; 522c; 922c; 1022c) spaced apart in the vehicle transverse direction and extending in the vehicle vertical direction, whose intermediate space is engaged by the support rail (130; 230; 330; 430; 530; 630; 730; 830).

16. The tracked vehicle according to claim 1,
characterized in that
the means of guidance include a guide profile (622b) on the chain links (622), where this guide profile has a guide section (622d) extending in the vehicle vertical direction which engages a groove (630a) on an underside of the support rail (630) which extends in the vehicle longitudinal direction.

17. The tracked vehicle according to claim 1,
characterized in that
the support rails (130) are each attached to a support frame (132), the support frame (132) being designed in each case to be attached to at least one axle (118) of the tracked vehicle extending in the vehicle transverse direction.

18. The tracked vehicle according to claim 1,
characterized in that
the support rails (130; 230; 330; 430; 530; 630; 730; 830; 930) are each bent upward in the vehicle vertical direction on at least one end.

19. The tracked vehicle according to claim 1,
characterized in that
there are rollers (830b) mounted on the underside of the support rail (830), which are in contact with the chain (10) in the contact section when in operation.

20. The tracked vehicle according to claim 1,
characterized in that
support elements (922b; 1022b) are provided on the chains, against which support elements the support rails bear, the support elements (922b; 1022b) each having on their top at least one roller (974; 974a, 974b; 1074a, 1074b) which is mounted so that it can rotate around a vehicle transverse axis (6).

21. The tracked vehicle according to claim 1,
characterized in that
there are at least two support rails (730) provided on each chain, each of which is designed in a contact section (710e, 710f, 710g) for constant contact with the ground-side chain section, with the contact sections (710e, 710f, 710g) overlapping in the vehicle longitudinal direction.

22. The tracked vehicle according to claim 1,
characterized in that
the support rails (130; 230; 330; 430; 530; 630; 730; 830; 930; 1030) are made of a plastic, at least in the area of a lower contact surface (1062a) that is designed for contact with the ground-side chain section.

23. The tracked vehicle according to claim 1,
characterized in that
the support rails (130; 230; 330; 430; 530; 630; 730; 830; 930; 1030) are made of a plastic in the area of lateral contact surfaces (1062a) that are provided for contact with the chain-side guide sections that extend in the vehicle vertical direction.

24. The tracked vehicle according to claim 22,
characterized in that
polyamide is provided as the plastic on the lower and/or lateral contact surfaces (1062a, 1062b), at least in some sections, preferably PA 6 or PA 12.

25. The tracked vehicle according to claim 22,
characterized in that
a plastic layer less than 12 mm thick is provided on the lower and/or lateral contact surfaces (1062a, 1062b).

26. The tracked vehicle according to claim 22,
characterized in that
the lower and/or lateral contact surface is formed from a plurality of discrete contact surface sections (962a, 962b, 962c, 962d, 962e).

27. The tracked vehicle according to claim 1,
characterized in that
assigned to each chain (110; 210; 410; 510) is a supporting rail (150; 250; 4560; 550) oriented in the vehicle longitudinal direction to guide a section of the particular chain that faces away from the ground.

28. The tracked vehicle according to claim 27,
characterized in that
the support rails (150; 250; 4560; 550) are made of a plastic, at least in the area of an upper contact surface that is provided for contact with the section of the particular chain (110; 210; 410; 510) that faces away from the ground.
